(19) United States
(12) Patent Application Publication
(10) Pub. No.: US 2021/0209298 A1
(43) Pub. Date: Jul. 8, 2021

(54) COMPUTER-IMPLEMENTED SYSTEMS AND METHODS FOR MANAGING AN ELECTRONIC DOCUMENT

(71) Applicant: COUPANG CORP., Seoul (KR)

(72) Inventors: Byoung In LIM, Seoul (KR); Jin Su LEE, Seoul (KR); Seon Ah KIM, Seoul (KR); Jun Young MUN, Seoul (KR); Suk Min AHN, Seoul (KR)

(21) Appl. No.: 16/733,511

(22) Filed: Jan. 3, 2020

(51) Int. Cl. G06F 40/186; G06F 16/95; G06F 16/908; G06F 16/93

(52) U.S. Cl. CPC G06F 40/186; G06F 16/93; G06F 16/908; G06F 16/95

(57) ABSTRACT

Disclosed embodiments provide systems and methods for managing an electronic document. A method for managing an electronic document comprises preparing an interface for defining a property by defining metadata associated with the property and selecting a stored property, providing the interface to a first user device, receiving a definable property from the user device, preparing a template comprising the definable property. The method further comprises transmitting the prepared template to a second user device, receiving an updated template comprising data for the definable property from the second user device, and generating an electronic document comprising the updated template.

### TECHNICAL FIELD

The present disclosure generally relates to computerized systems and methods for managing an electronic document. In particular, embodiments of the present disclosure relate to inventive and unconventional computer-implemented systems, methods, and user interfaces for conveniently generating an electronic document by defining a property and generating a template comprising the defined property.

### BACKGROUND

Electronic systems that allow for executing an electronic contract often utilize a template comprising metadata. For example, a template may include sections that require signatures, texts, and numbers in the form of metadata from appropriate parties. However, a party executing the contract is required to manually spot and fill in the required fields and it leads to critical omissions for the execution of contract.

To mitigate such problems, conventional electronic systems actualize an electronic input form for users and provide the actualized input form to parties to execute a contract. However, each template is required to be processed to generate an electronic input form, which requires steps of planning, designing, actualizing, validating, and providing. Thus, templates comprising metadata may not be fully utilized to conveniently generate an electronic contract, because each contract requires different metadata, which requires a new contract for each situation.

Therefore, there is a need for improved methods and systems for managing an electronic document by defining a property and generating a template comprising the defined property.

### SUMMARY

One aspect of the present disclosure is directed to a computer-implemented system for managing an electronic document. The computer implemented system may include one or more memory devices storing instructions. The computer-implemented system may also include one or more processors configured to execute the instructions to perform operations. The operations may comprise receiving, from a first user device, a request for constructing a template for an electronic document, preparing an interface comprising one or more inputs for defining a property by defining metadata associated with the property and a selectable element for selecting a stored property, and responding to the received request by providing the interface to a web browser on the first user device. The operations may further comprise receiving a definable property and a selected property from the interface, determining, by the one or more processors, one or more definable properties requiring inputs based on metadata associated with the received definable property and the received selected property, preparing a template comprising a definable input based on the determination, and transmitting the prepared template to a second user device. The operations may further comprise receiving an updated template, based on the transmitted template, comprising the defined input corresponding to the definable property from the user device and generating an electronic document formatted to comply with the received updated template.

Another aspect of the present disclosure is directed to a method for managing an electronic document attachment data. The method may comprise receiving, from a first user device, a request for constructing a template for an electronic document, preparing an interface comprising one or more inputs for defining a property by defining metadata associated with the property and a selectable element for selecting a stored property, and responding to the received request by providing the interface to a web browser on the first user device. The method may further comprise receiving a definable property and a selected property from the interface, determining, by the one or more processors, one or more definable properties requiring inputs based on metadata associated with the received definable property and the received selected property, preparing a template comprising a definable input based on the determination, and transmitting the prepared template to a second user device. The method may further comprise receiving an updated template, based on the transmitted template, comprising the defined input corresponding to the definable property from the user device and generating an electronic document formatted to comply with the received updated template.

Yet another aspect of the present disclosure is directed to a computer-implemented system for managing an electronic document. The computer implemented system may include a database and one or more memory devices storing instructions. The computer-implemented system may also include one or more processors configured to execute the instructions to perform operations. The operations may comprise receiving, from a first user device, a request for constructing a template for an electronic document, preparing an interface for selecting a stored property in the database, and responding to the received request by providing the interface to a web browser on the first user device. The operations may further comprise receiving a selected property from the interface, determining, by the one or more processors, one or more definable properties requiring inputs based on metadata associated with the received selected property, preparing a template comprising a definable input based on the determination, and transmitting the prepared template to a second user device. The operations may further comprise receiving an updated template, based on the transmitted template, comprising the defined input corresponding to the definable property from the user device and generating an electronic document including formatted to comply with the received updated template.

Other systems, methods, and computer-readable media are also discussed herein.

### BRIEF DESCRIPTION OF THE DRAWINGS

FIG. 1 depicts a block diagram of an exemplary computer system, consistent with the disclosed embodiments.

FIG. 2 depicts a logical diagram of an exemplary system for defining, inserting, and digitizing attachment data, consistent with the disclosed embodiments.

FIG. 3A is exemplary flow chart of process for generating an electronic document by defining properties and using a template comprising the definable properties, consistent with the disclosed embodiments

FIG. 3B is a continuing exemplary flow chart of process for generating an electronic document by defining properties and using a template comprising the definable properties, consistent with the disclosed embodiments.

FIG. 4 depicts an exemplary user interface of a user device displayed on web browser for defining a property comprising one or more metadata, consistent with the disclosed embodiments.

FIG. 5 depicts an exemplary user interface of a user device displayed on web browser for configuring received definable properties from user interface in FIG. 4, consistent with the disclosed embodiments.

FIG. 6 depicts an exemplary template presented on web browser of user device for generating an electronic document, consistent with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

Embodiments of the present disclosure are directed to systems and methods configured for managing an electronic document. The disclosed embodiments provide innovative technical features that allow defining a property, preparing a template comprising the defined property, generating an electronic document based on the template and data entered in the template. For example, the disclosed embodiments enable preparation of an interface for defining a property of an electronic document and transmission of the interface to a first user device, receiving the definable property from the first user device, convenient preparation of a template comprising a definable input corresponding to the received definable property and transmission of the template to a second user device, receiving an updated template from the second user device, and generating an electronic document based on the updated template.

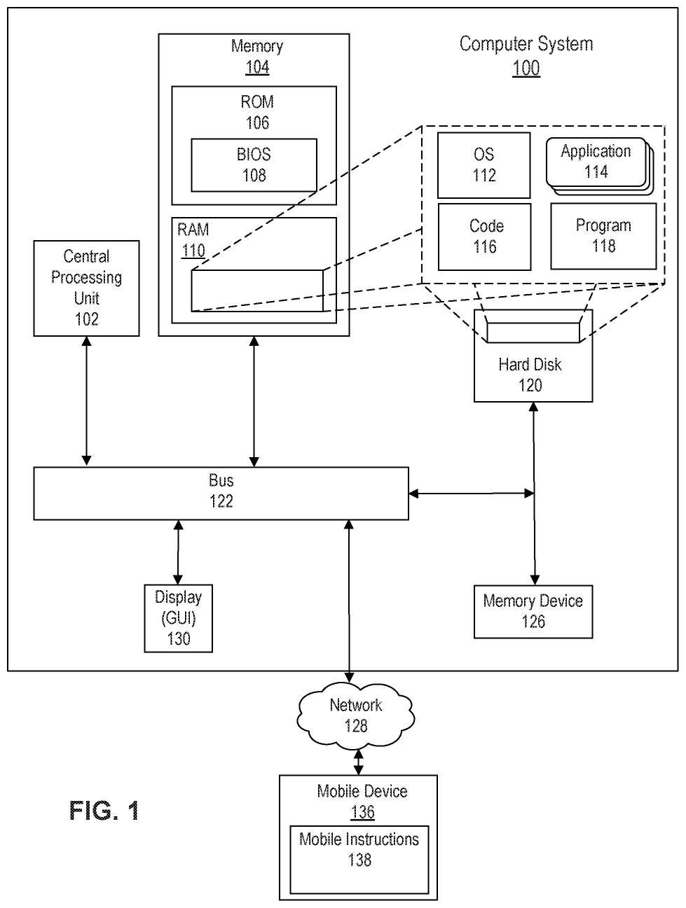

FIG. 1 depicts a block diagram of an exemplary computer system 100, consistent with disclosed embodiments. Components of system 100 may include a central processing unit (CPU) or processor 102, a memory unit 104, and a bus 122 that interconnects system components including memory 104 and CPU 102. Computer system 100 can include computer-readable media, such as volatile or nonvolatile computer storage media implemented in a method or technology suitable for storing computer-readable instructions, data structures, program modules, of the like (e.g., RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other suitable medium).

Bus 122 can be a suitable type of bus structure, such as a memory bus or memory controller, a peripheral bus, and a local bus using a suitable bus architecture. By way of example, and not limitation, such architectures can include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus—also known as Mezzanine bus.

Memory 104 can include computer-readable media, such as read only memory (ROM) 106 and random access memory (RAM) 110. A basic input/output system (BIOS) 108, containing the basic routines that help to transfer information between elements within computer system 100 is typically stored in ROM 106. Additionally, RAM 110 may contain operating system (OS) 112, applications 114, other code 116 that may be executed by one or more different programs, and program 118. RAM 110 typically contains data and/or program modules that are immediately accessible to and/or presently being operated on by CPU 102.

Hard disk drive 120 can be removable/non-removable and volatile/nonvolatile computer media. The hard disk drive 120 can read from or write to non-removable, nonvolatile magnetic media, and a memory device 126. Other removable/non-removable and volatile/nonvolatile computer storage media that can be used in exemplary computer system 100 include, but are not limited to, magnetic tape cassettes, flash memory cards, digital versatile disks, digital video tape, solid state RAM, and solid state ROM. The disks and their associated computer media, discussed above and illustrated in FIG. 1, provide storage of computer-readable instructions, programmable code, data structures, program modules and other data for computer system 100. In FIG. 1, hard disk 120 is illustrated as storing an operating system (OS) 112, one or more applications 114, other programmable code 116, and a program 118.

Memory device 126 can be an optical disk drive or a magnetic disk drive that reads from or writes to a removable and nonvolatile storage medium such as an optical disk or magnetic disk.

A user can enter commands and information into computer system 100 through an input device such as a keyboard and mouse, trackball or touch pad tablet, electronic digitizer, or microphone. Other input devices can include a joystick, game pad, satellite dish, or scanner. These and other input devices can be connected to CPU 102 through an input interface that is coupled to bus 122, or through other interfaces or bus structures, such as a parallel port, game port or a universal serial bus (USB). A display (GUI) 130 or other type of video device can also be connected to bus 122 via an interface, such as a video interface. In addition, an output device, such as speakers or a printer, can be connected to bus 122 through an output interface.

Computer system 100 can operate in a networked environment using a network 128 and a mobile device 136. Mobile device 126 can be used by a user who wants to manipulate metadata incorporated in an attachment to an electronic document. Computer system 100 can also include a personal computer, a server, a router, a network PC, a peer device or other common network node. Mobile device 136 can include a handheld, tablet, or client device. Network 128 depicted in FIG. 1 can include a local area network (LAN), a wide area network (WAN), or other type of network. Such networking environments are commonplace in offices, enterprise-wide computer networks, intranets, and the Internet. In a networked environment, programmable code and application programs can be stored in remote computers. By way of example, FIG. 1 illustrates mobile instructions 138 as residing on mobile device 136. It will be appreciated that the network connections shown are exemplary and other means of establishing communication between computers and mobile device 136 can be used.

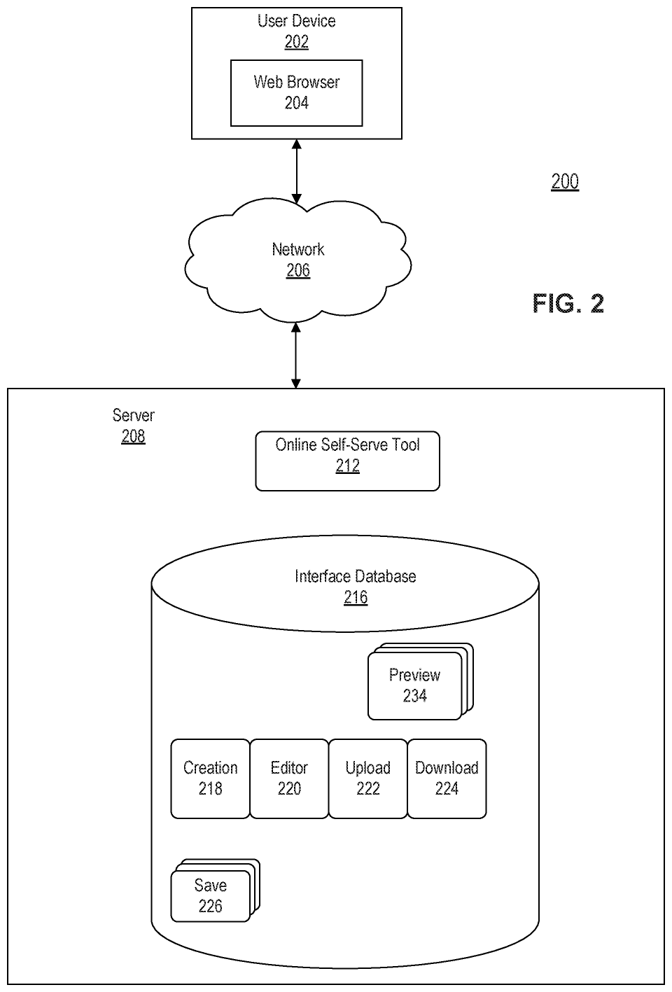

FIG. 2 depicts a logical diagram of an exemplary system for manipulating metadata incorporated attached to an electronic document, consistent with disclosed embodiments. In various embodiments, a user device 202 can be mobile device 136 or any other computing device, such as computer system 100 of FIG. 1. User device 202 can be operably coupled to one or more servers 208 by a network 206.

Network 206 can be a suitable network, such as a local area network (LAN), a wide area network (WAN), or other type of network. A web browser 204 can execute on computer 100 (as shown) or mobile device 136 (not shown), and web browser 204 can include functionality for receiving data entered at user device 202 as part of a self-serve tool consisting of a plurality of graphical user interfaces (GUIs). In general, web browser 204 can be implemented using interpreted or executable software code such as a kernel component, an application program, a script, a linked library, an object with methods, and so forth. The particular implementation of web browser 204 is not intended to be limiting. Web browser 204 can be configured to display interfaces, such as the interfaces described herein, for interacting with the disclosed system for manipulating metadata incorporated in an attachment of electronic document. As would be appreciated by those of skill in the art, additional interfaces may also be used to interact with the disclosed system.

Server 208 can be a suitable computer system or computing device, such as computer system 100 of FIG. 1. In some instances, server 208 can be part of a cloud computing platform. In various instances, server 208 can be configured to host at least one of online self-serve tool 212 or interface database 216.

Interface database 216 can include a creation interface 218, an editor interface 220, an upload interface 222, and a download interface 224. Creation interface 218 may enable user device 202 to create a property, file or document in interface database 216 and editor interface 220 may enable user to edit a property, file or document stored in interface database 216. Upload interface 222 may enable user device 202 to upload a property, file or document in interface database 216 and download interface 224 may enable user device 202 to download a property, file or document stored in interface database 216.

Interface database 216 can also include multiple save interfaces 226 and multiple preview interfaces 234. Save interfaces 226 may enable user device 202 to save a property, file or document in interface database 216 and preview interfaces 234 may enable user device 202 to preview a file or document stored in interface database 216. Other interfaces (not shown) can be contemplated for display to user device 202 and for interacting with online self-serve tool 212. Each of the interfaces and associated modules for displaying the interfaces can include suitable executable software code such as a kernel component, an application program, a linked library, an object with methods, or other type of executable software code. User device 202 can utilize one or more of the interfaces to manipulate metadata.

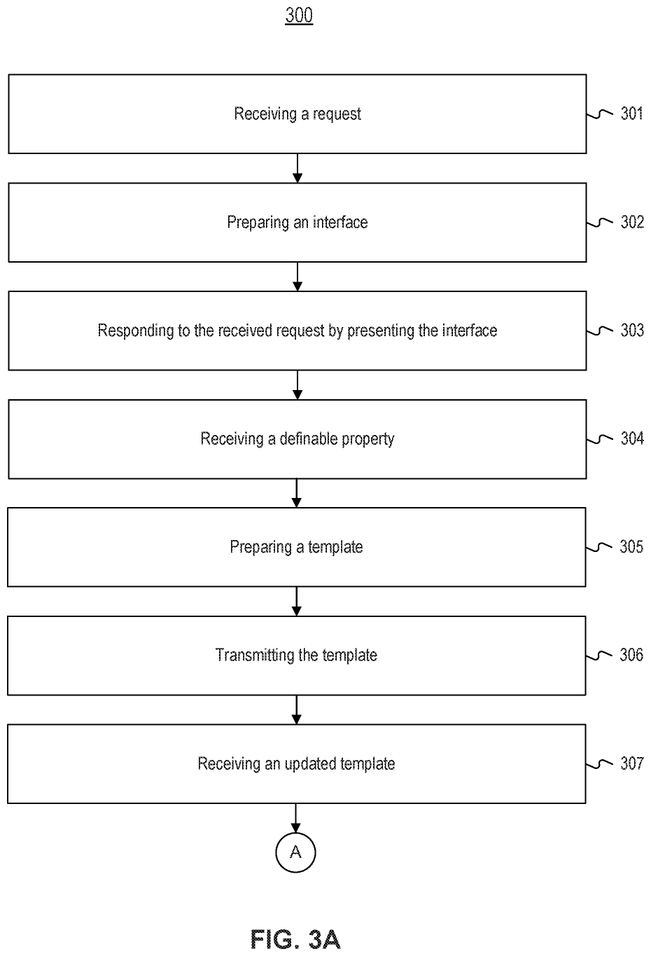

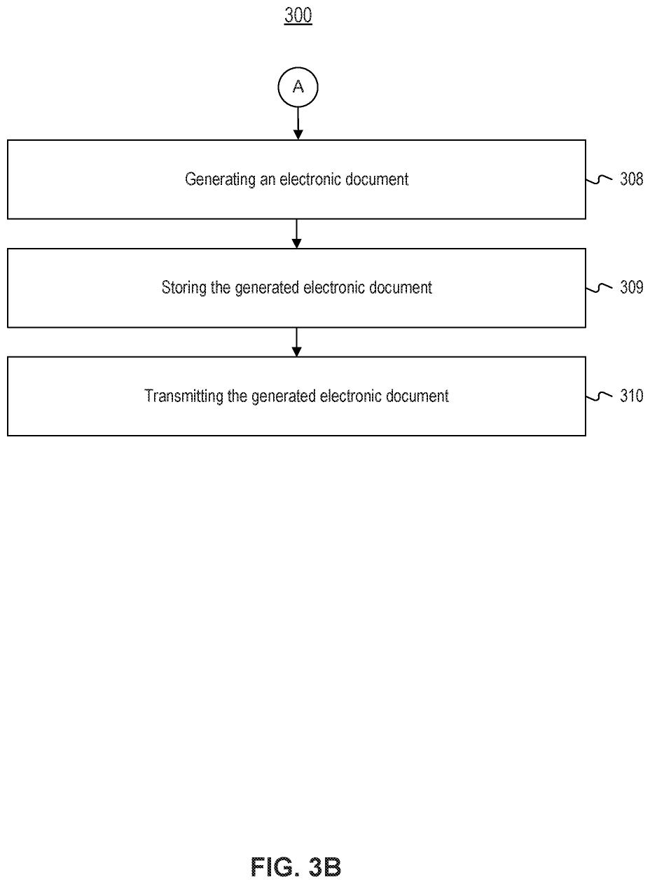

FIG. 3A is an exemplary flow chart of process 300 for generating an electronic document by defining properties and using a template comprising the definable properties, consistent with the disclosed embodiments. This exemplary method is provided by way of example. Method 300 shown in FIG. 3A can be executed or otherwise performed by server 208. Method 300 as described below may be carried out by server 208 by way of example. Each block shown in FIG. 3A represents one or more processes, methods, or subroutines in the exemplary method 300. Referring to FIG. 3A, exemplary method 300 may begin at block 301.

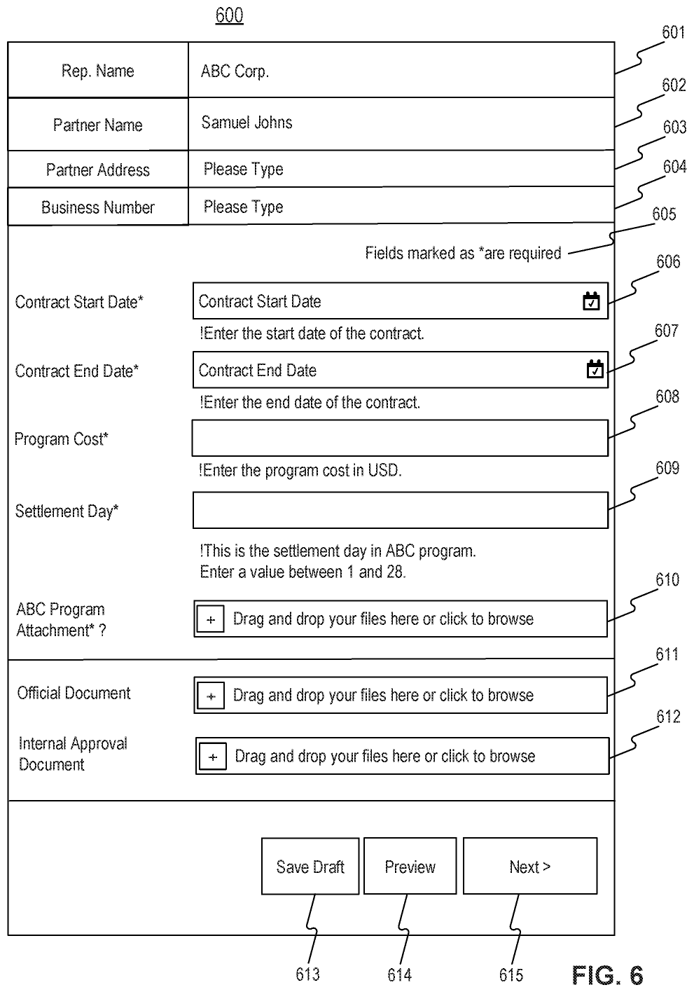

In step 301, server 208 may receive a request for constructing a template for generating an electronic document from a user device 202. While user device 202 is referenced in explaining the method of FIG. 3A, it should be noted that devices with similar capacities and components of computer system 100 may carry out the method of FIG. 3A, as appropriate. The template, described below in further detail with respect to FIG. 6, may provide input fields for a computing device associated with a responsible party to enter appropriate data for a corresponding property and server 208 may generate an electronic document based on the data entered in the template. User device 202 may use a web browser 204 displayed on the user device 202 to transmit the request for constructing a template for generating an electronic document. For example, web browser 204 may provide a user interface for requesting a construction of template, and user device 202 may configure a control implemented in the user interface to request the construction. The control may be in the form of a button that a user associated with user device 202 can press or click the button to request the construction.

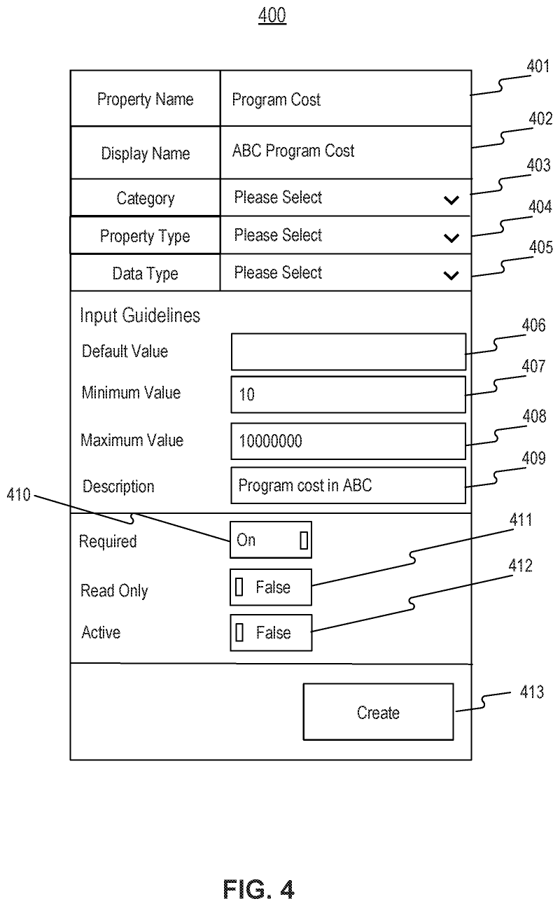

In step 302, server 208 may prepare an interface comprising one or more inputs for defining a property in the template. The exemplary properties may include a representative name, a partner name, a partner address, a business number, a signature block, a contract start date, a contract end date, a program cost, a settlement day, etc. The interface may include one or more inputs for defining corresponding metadata, the metadata further define a property. The one or more inputs can be defined when a user associated with user device 202 enters data to the inputs. The exemplary interface comprising inputs defining metadata of a property is illustrated in FIG. 4 and will be discussed in more detail.

In step 303, server 208 may respond to the received request from step 301 by presenting the user interface prepared in step 302 within a web browser 204 in user device 202. A user associated with user device 202 may use web browser 204 displayed on the user device 202 to define a property by entering data in the user interface to define metadata associated with the property. After defining the property, user device 202 may transmit the definable property to the server 208. For example, a user associated with user device 202 may configure a control implemented in the user interface to transmit a definable property to server 208. The control may be in the form of a button or a selectable element that user can press or click to transmit the defined attribute.

In some embodiments, the user interface may also enable user device 202 to select a property from properties stored in interface database 216 as a definable property. A property can be stored in the database by using save interface 226. The interface database 216 is discussed above with respect to FIG. 2 for including save interfaces 226 to save a property, file, or document in interface database 216. A user associated with user device 202 may use the user interface displayed on the user device 202 to select a stored property and transmit the selected property as a definable property to the server 208. Moreover, it is appreciated that user device 202 may transmit one or more definable property to server 208 by using the user interface prepared in step 302.

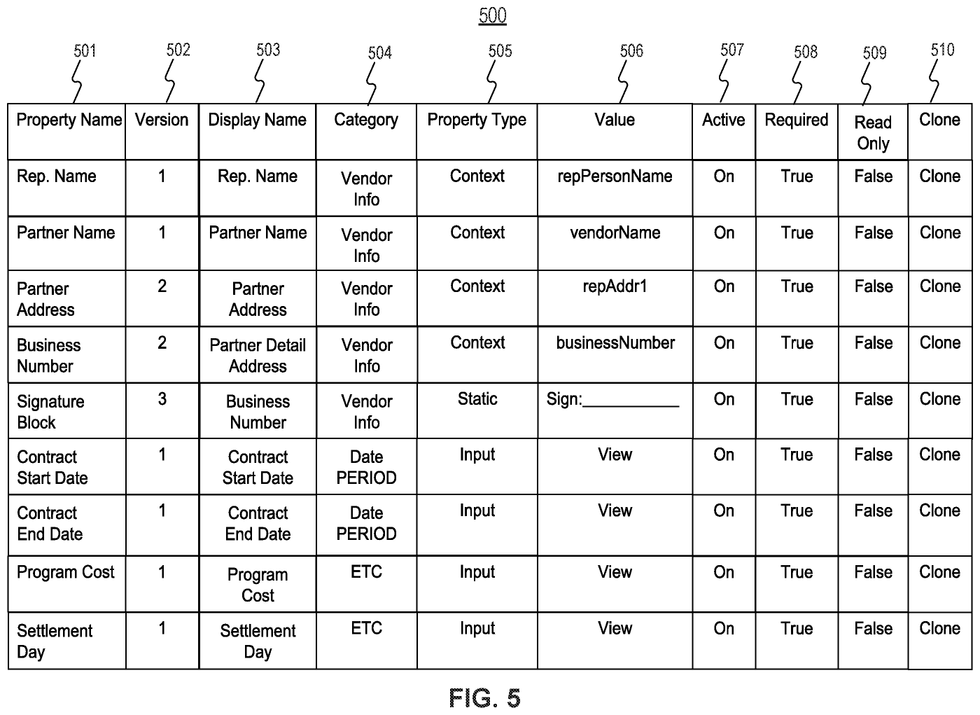

In step 304, server 208 may receive the definable property from the interface presented in step 303 transmitted from the user device 202. Exemplary definable properties, coupled with metadata associated with each of the definable properties, are depicted in FIG. 5 and will be discussed in more detail. In some embodiments, server 208 may enable user device 202 to enable or disable one or more definable properties by providing editor interface 220 on web browser 208 in the user device 202. Server 208 may also enable user device 202 to clone a property. Editor interface 220 may provide controls for an enablement of property and a cloning of property. The control may be in the form of a button or a selectable element that user can press or click to initiate the selected action.

In step 305, server 208 may prepare a template comprising one or more received definable properties. When a received definable property requires an input to define the definable property, server 208 may prepare an input field or any suitable elements to enable user device 202 to enter data to define the definable property. The exemplary template comprising definable properties is illustrated in FIG. 6 and is discussed in more detail below.

In step 306, server 208 may transmit the prepared template to a second user device associated with a party responsible to enter data in the template. In some embodiments, server 208 may enable a second user device to define an input corresponding to the definable property by entering data to the input by using a web browser. For example, server 208 may enable a second user device to define an input by providing editor interface 220 to the second user device. In another embodiment, server 208 may enable a second user device to define an input by enabling the second user device to download the template, define an input by entering data in the template, and upload or transmit the updated template to server 208. For example, server 208 may provide download interface 224 for a second user device to download a template and upload interface 222 to upload an updated template. FIG. 6 depicts an exemplary template 600 comprising eleven properties 601-604 and 606-612. The second user device may enter data as required by the template via web browser in the second user device. While eleven properties 601-604 and 606-612 are provided in the exemplary template 600, it is appreciated that user device 202 can prepare a template with other numbers of properties by transmitting a desired number of properties to server 208.

In step 307, server 208 may receive an updated template from the second user device. When server 208 receives the updated template, server 208 may determine whether all required properties have been defined by the second user device. An input requirement of property can be indicated by a defined metadata. If server 208 determines that the required property is not defined, in some embodiments, server 208 may transmit the updated template to the second user device with an indication that an input is required to define the property. For example, if a required property “Program Cost” is not defined in the updated template, server 208 may transmit the updated template or a message back to the second user device with an indication stating, “Required field is not defined, please define the required field.” A property can be configured to be required by actuating button 410 implemented in user interface 400 in FIG. 4. When all required properties have been defined in the updated template, server 208, in step 308 (depicted in FIG. 3B), may generate an electronic document comprising the template and the inputs received from the second user device.

In some embodiments, server 208 may also determine whether the defined input matches the data format. If server 208 determines that the defined input does not match the data format, in some embodiments, server 208 may transmit the template or a message back to the second user device with an indication stating, “Wrong data format has been entered, please re-enter the appropriate data.” For example, if a word “ABCDE” is defined as input for a property associated with integer data format, server 208 may transmit the template back to the second user device.

In step 309, server 208 may store the generated electronic document from step 308 in interface database 216. In some embodiments, server 208 may automatically store the generated electronic document in interface database 216. In another embodiment, server 208 may enable the second user device to save the generated electronic document by providing save interface 226 to the second user device. User device 202 or another computing device can access server 208 and easily retrieve the electronic document and the definable property. The definable property can be retrieved and used in another template to generate another electronic document. In step 310, server 208 may transmit the generated electronic document to user device 202.

FIG. 4 depicts an exemplary user interface 400 of a user device 202 displayed on web browser 204 for defining a property comprising one or more metadata, consistent with the disclosed embodiment. The defined property is inserted in a template and the template is configured to receive an input for the defined property from user device 202 for generating an electronic document. Interface 400 may include inputs 401 and 402, and dropdown menus 403-405. The exemplary user interface 400 is depicted to define “Program Cost” using five pieces of metadata, but one of ordinary skill in the art would understand that user interface may be implemented to define other types of properties.

A user may enter data in inputs 401 and 402 to define names of property. For example, as shown in FIG. 4, a user may enter property “Program Cost” in input 401 and display name “ABC Coupon Product” in input 402. Dropdown menus 403-405 may define metadata associated with the property. Dropdown menu 403 may define a category of property. Exemplary categories may include a vendor information, a corporate information, a date period, etc. Dropdown menu 404 may define a property type. Exemplary property types may include a context, a static, an input, etc. The exemplary property types are illustrated in FIG. 5 and FIG. 6 and will be discussed in more detail. Drop down menu 404 may define a data format of property.

User interface 400 may also include inputs 406-409 for defining an input guideline. The input guideline may instruct a user to insert appropriate data in the template. A user may enter data in input 406 to define a default value associated with the property. For example, if the property is associated with a cost, a user may define a default cost if it is not further defined in the template. A user may also enter data in inputs 407 and 408 to define a minimum value of property and a maximum value of property, respectively. For example, if the property is associated with a cost and input 407 defines $10 as a minimum cost and input 408 defines $1,000 as a maximum cost, the property is configured to receive only an amount between $10 and $1,000. Input 409 may provide a description statement assisting a user to enter appropriate data for an input corresponding to the property.

User interface 400 may further include buttons 410-413. Button 410 may enable a user to define a requirement of property. For example, if button 410 is configured to “On”, a template requires a user to enter data for the property. By way of further example, if button 410 is configured to “Off”, a template does not require a user to enter data for the property. Button 411 may enable a user to configure a configurability of the property. For example, if button 411 is configured to “True”, a template may not allow a user to configure the property. By way of further example, if button 411 is configured to “False”, a template may allow user to configure the property. Button 412 may enable a user to define an activeness of property. For example, if button 412 is configured to “True”, the property is enabled as an active component in a template. By way of further example, if button 412 is configured to “False”, the property is disabled as an active component in a template. Button 413 may enable user interface 400 to transmit a defined property to server 208. When user interface 400 receives a press on the button 413, user interface 400 may transmit a definable property and metadata associated with the definable property to server 208 as discussed above with respect to FIG. 3A.

FIG. 5 depicts an exemplary user interface 500 of a user device 202 displayed on web browser 204 for configuring received definable properties from user interface 400 in FIG. 4, consistent with the disclosed embodiment. Receiving a definable property is discussed above with respect to step 304 in FIG. 3A. The received definable property may be used to prepare a template and the template will be discussed in FIG. 6. The definable property 500 may comprise metadata 501 and 503-509, and indicator 502, and button 510. Metadata 501 and 503-509 correspond to metadata used to define property in FIG. 4. For example, metadata 504 may refer to a property type defined in input 403 in FIG. 4. Indicator 502 may refer to a version of each property. The version of property may provide a history of property such as how many times the property is defined. A user may select a different version of property by selecting a desired of version of property using indicator 502. When different version is selected, user interface 500 may present metadata 501 and 503-509 corresponding to the version of property and further use the version of property to prepare a template. Metadata 507 may provide an enablement of a property configured by button 412 in FIG. 4. User interface 500 may enable user to enable or disable the property by further configuring metadata 507 on the user interface 500. For example, a user may disable an enabled property by configuring corresponding metadata 507 to “Off”. Button 510 may enable a user to clone a property. When the property is cloned by receiving a press on button 510, the property may appear multiple times in a template based on its metadata (such as metadata 507 presenting an enablement of property).

FIG. 6 depicts an exemplary template 600 presented on web browser 204 of user device 202 for generating an electronic document, consistent with the disclosed embodiment. Transmitting template 600 to user device 202 is discussed above with respect to step 306 in FIG. 3A. Template 600 may include inputs 601-604 and 606-612 corresponding to each of received definable property and buttons 613-616. While exemplary template 600 presents eleven properties, it is appreciated that different number of properties can be included in a template. Inputs 601-604 may correspond to properties associated with a context property type. Appropriate inputs may be entered in the form of texts or numbers. Template 600 may also include an indicator 605 which describes a required property.

Inputs 606-609 may correspond to properties associated with an input type. Inputs 606 and 607 are further associated with a date period, thus a user may enter dates manually or use icons in inputs 606 and 607 to pop up a calendar configured to allow the user to select dates. User Interface 600 includes input guidelines for inputs 606-609 that may instruct a user on entering appropriate data for each of the inputs 606-609. Server 208 may store the input guidelines in interface database 216. Inputs 610-612 may correspond to properties associated with an attachment type. A user may attach a document or file to inputs 610-612.

Template 600 may also include buttons 613-615. Button 613, when receiving a press, may save data entered in template 600 in interface database 216. Button 614, when receiving a press, may enable a user to preview an electronic document comprising template 600 and data entered in the template 600. Button 615, when receiving a press, may transmit template 600 coupled with data entered in puts 601-604 and 606-612 to server 208 to generate an electronic document. The generated electronic document is further stored in interface database 216.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

1. A computer-implemented system for managing an electronic document by generating a template for the electronic document, comprising:
one or more memory devices storing instructions; and
one or more processors configured to execute the instructions to perform operations comprising:
receiving, from a first user device, a request for constructing a template for an electronic document;
preparing an interface comprising one or more inputs for defining a property by defining metadata associated with the property, a version of the property, and a first selectable element for selecting a stored property and a second selectable element for selecting the version of the property, wherein the defined metadata corresponds to the version of the property and provides enablement of the defined property;
responding to the received request by providing the interface to a web browser on the first user device;
receiving a definable property and a selected property from the interface;
determining, by the one or more processors, one or more definable properties requiring inputs based on metadata associated with the received definable property and the received selected property;
preparing a template comprising a definable input based on the determination;
transmitting the prepared template to a second user device;
receiving an updated template, based on the transmitted template;
determining if the definable property of the received updated template includes the defined input;
upon determining that the definable property of the received updated template does not include the defined input, transmitting the updated template back to the second user device with an indication that an input is required to define the definable property;
receiving the updated template back from the second user device, wherein the updated template comprises the defined input corresponding to the definable property; and
generating an electronic document formatted to comply with the received updated template.

2. The computer-implemented system of claim 1, wherein preparing a template comprising a definable input further comprises generating a template comprising a definable input corresponding to an attribute of the received definable metadata.

3. The computer-implemented system of claim 1, wherein the prepared template provides a consistency indication between a received definable input and the data type.

4. The computer-implemented system of claim 1, wherein the prepared interface further comprises a guideline for inserting data comprising for a user associated with a second user device:
an input for default value;
an input for minimum value;
an input for maximum value; or
an input for description.

5. The computer-implemented system of claim 4, wherein the prepared template provides the guideline for inserting data for a definable input.

6. The computer-implemented system of claim 4, wherein the input for default value is used as the defined input in the updated template when the received updated template does not define the property.

7. The computer-implemented system of claim 1, wherein the prepared interface further comprises a requirement indicator, a read-only indicator, or an activation indicator.

8. The computer-implemented system of claim 1, wherein the property comprises a representative person name, a vendor name, a vendor address, a detailed vendor address, a vendor identifier, a business number, a signature block for vendor, a retailer address, a signature block for retailer, a signature block for signing date, a retailer name, a retailer business number, a contract start date, a contract end date, a program cost, or a settlement date.

9. The computer-implemented system of claim 1, wherein the operations further comprise storing the generated electronic document and transmitting the generated electronic document to the first user device.

10. The computer-implemented system of claim 1, wherein the operations further comprise storing the received definable property.

11. A method for managing an electronic document by generating a template for the electronic document, comprising:
receiving, from a first user device, a request for constructing a template for an electronic document;
preparing an interface comprising one or more inputs for defining a property by defining metadata associated with the property, a version of the property, and a first selectable element for selecting a stored property and a second selectable element for selecting the version of the property, wherein the defined metadata corresponds to the version of the property and provides enablement of the defined property;
responding to the received request by presenting the interface within a web browser in the first user device;
receiving a definable property and a selected property from the interface;
determining, by the one or more processors, one or more definable properties requiring inputs based on metadata associated with the received definable property and the received selected property;
preparing a template comprising a definable input based on the determination;
transmitting the prepared template to a second user device;
receiving an updated template, based on the transmitted template;
determining if the definable property of the received updated template includes the defined input:
upon determining that the definable property of the received updated template does not include the defined input, transmitting the updated template back to the second user device with an indication that an input is required to define the definable property;
receiving the updated template back from the second user device, wherein the updated template comprises the defined input corresponding to the definable property; and
generating an electronic document including formatted to comply with the received updated template.

12. The method of claim 11, wherein preparing a template comprising a definable input further comprises automatically generating a template comprising a definable input corresponding to an attribute of the received definable metadata.

13. The method of claim 11, wherein the prepared template provides a consistency indication between a received definable input and the data type.

14. The method of claim 11, wherein the prepared interface further comprises a guideline for inserting data comprising for a user associated with a second user device:
an input for default value;
an input for minimum value;
an input for maximum value; and
an input for description.

15. The method of claim 14, wherein the prepared template provides the guideline for inserting data for a definable input.

16. The method of claim 14, wherein the input for default value is used as the defined input in the updated template when the received updated template does not define the property.

17. The method of claim 11, wherein the prepared interface further comprises a requirement indicator, a read-only indicator, and an activation indicator.

18. The method of claim 11, wherein the property comprises a representative person name, a vendor name, a vendor address, a detailed vendor address, a vendor identifier, a business number, a signature block for vendor, a retailer address, a signature block for retailer, a signature block for signing date, a retailer name, a retailer business number, a contract start date, a contract end date, a program cost, or a settlement date.

19. The method of claim 11, wherein the operations further comprise storing the generated electronic document and transmitting the generated electronic document to the first user device.

20. A computer-implemented system for managing an electronic document by generating a template for the electronic document, comprising:
a database for storing properties;
one or more memory devices storing instructions; and
one or more processors configured to execute the instructions to perform operations comprising:
receiving, from a first user device, a request for using a stored property for constructing a template for an electronic document;
preparing an interface for selecting a stored property in the database and for selecting a version of the property;
responding to the received request by presenting the interface within a web browser in the first user device;
receiving a selected property from the interface;
determining, by the one or more processors, one or more definable properties requiring inputs based on metadata associated with the received selected property, wherein the metadata corresponds to the version of the property and provides enablement of the property;
preparing a template comprising a definable input corresponding to the received property;
transmitting the prepared template to a second user device;
receiving an updated template, based on the transmitted template;
determining if the definable property of the received updated template includes the defined input:
upon determining that the definable property of the received updated template does not include the defined input, transmitting the updated template back to the second user device with an indication that an input is required to define the definable property; and
receiving the updated template back from the second user device, wherein the updated template comprises the defined input corresponding to the definable property; and
generating an electronic document including the received updated template.
